(19) United States
(12) Patent Application Publication
(10) Pub. No.: US 2014/0103858 A1
(43) Pub. Date: Apr. 17, 2014

(54) MOBILE CHARGING DEVICE

(71) Applicants: Klaus Bertsch, Frastanz (AT); Stefan Mayer, North Bondi (AU); Peter Roth, Grabs (CH)

(72) Inventors: Klaus Bertsch, Frastanz (AT); Stefan Mayer, North Bondi (AU); Peter Roth, Grabs (CH)

(73) Assignee: HILTI AKTIENGESELLSCHAFT, Schaan (LI)

(21) Appl. No.: 14/004,951

(22) PCT Filed: Feb. 16, 2012
(86) PCT No.: PCT/EP2012/052638

§ 371 Date: Dec. 20, 2013

(30) Foreign Application Priority Data
Mar. 16, 2011 (DE) 10 2011 005 646.7

(51) Int. Cl. H02J 7/00

(52) U.S. Cl. CPC H02J 7/0054
USPC 320/103

(57) ABSTRACT

The invention concerns a mobile charging device for at least one electrically operable tool device, which comprises at least one battery that can be charged by the mobile charging device.

In order to further simplify the operation of an electrically operable tool device, the mobile charging device comprises an energy storage device for the storage of electrical energy that can be used to charge the battery of the electrically operable tool device, independently of the mains supply.

### TECHNICAL FIELD

The invention concerns a mobile charging device for at least one electrically operable tool device, which comprises at least one battery that can be charged by the mobile charging device. The invention concerns, moreover, a charging system for at least two electrically operable tool devices, which comprise at least one battery that can be charged by such a mobile charging device. Furthermore, the invention concerns a method for the operation of such a charging system.

### STATE OF THE ART

An inductive charging station for electrically operable tool devices is known from U.S. Pat. No. U.S. 7,462,951 B1. An on-board battery charging device for the charging of the main battery of an electric storage road vehicle with a capacitive intermediate storage unit is known from German patent DE 33 05 224 A1 (Offenlegungsschrift).

### DESCRIPTION OF THE INVENTION

The goal of the invention is to further simplify the operation of an electrically operable tool device, which comprises at least one battery that can be charged by means of a mobile charging device.

With a mobile charging device for at least one electrically operable tool device, which comprises at least one battery that can be charged by means of the mobile charging device, the goal is attained in that the mobile charging device comprises an energy storage device for the storage of electrical energy, which can be used to charge the battery of the electrically operable tool device independently of the mains supply. In connection with the charging device, “mobile” means that the charging device can be carried or transported alone—independently of other devices or together with other devices. The German “Akku” is an abbreviation for accumulator (battery). Within the framework of the invention, however, other current storage units, such as condensers, can be charged by the mobile charging device. “Independently of the mains supply” means that the mobile charging device need not be connected to the power supply network in order to charge the battery of the electrically operable tool device. The energy storage device is preferably designed to be large enough that the battery can be charged at least once, perhaps several times, without the need to connect the mobile charging device to the power supply network for the purpose. It is also possible to charge several, perhaps different, batteries from the energy supply device of the mobile charging device. The tool devices are also preferably constructed such that they are mobile.

A preferred embodiment example of the mobile charging device is characterized in that the mobile charging device has an interface for the contactless and/or wireless energy transfer between the energy storage device and the battery of the electrically operable tool device. In accordance with another embodiment example, the mobile charging device has, alternatively or additionally, an interface for the contact energy transfer between the energy storage device and the battery of the electrically operable tool device. The interface is preferably constructed as a high-power interface. Under certain circumstances, the contactless and/or wireless energy transfer contributes to an increase in safety during the charging of the battery.

Another preferred embodiment example of the mobile charging device is characterized in that the interface for the contactless and/or wireless energy transfer is constructed in such a manner that currents of more than 100 amperes can be transferred. In such a way, very short charging times of the batteries are made possible.

Another preferred embodiment example of the mobile charging device is characterized in that the interface for the contactless and/or wireless energy transfer is correlated with a control interface. The control interface ensures that an energy transfer can take place only if the battery is arranged correctly, relative to the mobile charging device—for example, is plugged in or inserted and/or locked.

Another preferred embodiment example of the mobile charging device is characterized in that the mobile charging device has a mains connection for the charging of the energy storage device in the mobile charging device. The mains connection comprises, for example, a mains cable with a mains plug, but can also be wireless. The charging device in accordance with the invention can be operated via the mains connection like a traditional charging device in order to charge the battery or several batteries from a power supply network. By means of the design of the mobile charging device in accordance with the invention an additional charging possibility is made available from the energy storage device that is integrated into the mobile charging device.

Another preferred embodiment example of the mobile charging device is characterized in that the mobile charging device is integrated into a tool box, a backpack, or a belt. In this way, the handling and/or the transporting of the mobile charging device is/are simplified.

Another preferred embodiment example of the mobile charging device is characterized in that the mobile charging device has a photovoltaic panel, which is connected to the energy storage device in the mobile charging device for the energy transfer. Via the photovoltaic panel, it is possible to then charge the energy storage device integrated into the mobile charging device if the mobile charging device is not connected to a power supply network.

Another preferred embodiment example of the mobile charging device is characterized in that the mobile charging device has a converter upstream from the energy storage device and/or a charging regulator downstream from the energy storage device. “Upstream” in connection with the converter means that the converter is placed between a power supply network and the energy storage device. “Downstream” in connection with the charging regulator means that the charging regulator is placed between the energy storage device and the interface to the battery. The converter is used to remove electric energy from a connected electrical power supply network, to convert it, and to charge the energy storage device in the mobile charging device. The charging regulator ensures that the electrical energy stored in the electrical energy storage device is released to the battery in a controlled manner.

With a charging system for at least two electrically operable tool devices, which comprise at least one battery that can be charged by a mobile charging device described above, the goal indicated above is, alternatively or additionally, attained in that the batteries of the tool devices have interfaces for the contactless and/or wireless energy transfer between the energy storage device and the batteries and/or for the contactless and/or wireless energy transfer between the batteries of the electrically operable tool devices. In accordance with another embodiment example, the batteries of the tool devices have, alternatively or additionally, an interface for the contact energy transfer between the energy storage device and the battery and/or between the batteries of the electrically operable tool devices. By means of the contactless and/or wireless energy transfer, safety is increased under certain circumstances when operating the charging system. The preferably removable batteries can, in particular, be charged contactless, both by the energy storage device and also among one another. In this way, it is possible to charge the batteries of a greatly discharged tool device by the battery of another tool device that is not yet so strongly discharged. The energy of several available tool devices can thus be completely consumed even if only one tool device is used.

One preferred embodiment example of the charging system is characterized in that the mobile charging device and/or the batteries of the electrically operable tool devices have communication interfaces for the contactless and/or wireless data transfer between the energy storage device and the batteries, and/or for the contactless and/or for the wireless data transfer between the batteries of the electrically operable tool devices. Via the communication interfaces, consumption data can be exchanged between the energy storage device and the batteries and between the batteries, among one another, or can be transmitted to a control that is integrated into the mobile charging device. Moreover, it is possible to select service data and/or to undertake software updates via the communication interfaces.

Another preferred embodiment example of the charging system is characterized in that the batteries of the electrically operable tool devices have interfaces for the contactless and/or wireless energy transfer between the batteries and the electrically operable tool devices. In this way, safety in the operation of the charging system in accordance with the invention is further increased.

Another preferred embodiment example of the charging system is characterized in that the interfaces for the contactless and/or wireless energy transfer and the communication interfaces for the contactless and/or wireless data transfer are combined in a multifunction interface. The communication interfaces can, for example, be integrated by a modulation or weakening of an electromagnetic field used for the energy transfer into the interfaces for the energy transfer.

Another preferred embodiment example of the charging system is characterized in that the batteries of the electrically operable tool devices are smaller and/or lighter than traditional batteries of electrically operable tool devices. By means of the design of the charging system in accordance with the invention it is possible to reduce the weight and the size of the electrically operable tool devices.

Another preferred embodiment example of the charging system is characterized in that the electrically operable tool devices comprise hand tools, such as a drilling machine, a stud gun, a nail gun, a handheld driving device, or a measuring device. The aforementioned tool devices are preferably used in the construction industry, where the use of mains-operated devices is critical with respect to operating safety.

Moreover, the invention concerns a method for the operating of a charging system described above. By means of the charging system in accordance with the invention, for a user who, in a work rhythm, always uses a tool device for only a few minutes, and in the interim does not use the device for a few minutes, it is, for example, possible to use a small, light battery that can operate the tool device for only a few minutes and is charged on the mobile charging device during the time that it is not being used.

Other advantages, features, and details of the invention can be deduced from the following description, in which various embodiment examples are described in detail with reference to the figures. The figures show the following:

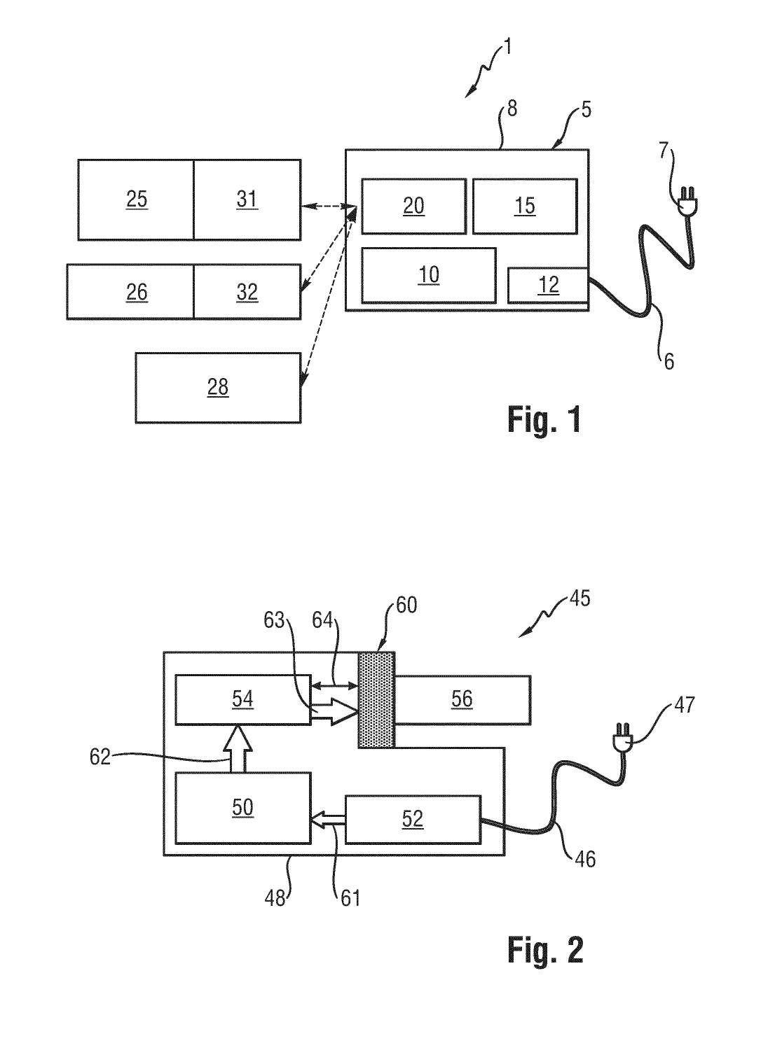

FIG. 1, a greatly simplified representation of a charging system in accordance with the invention with a mobile charging device and three electrically operable tool devices, in accordance with a first embodiment example;

FIG. 2, a mobile charging device with a battery, in accordance with another embodiment example;

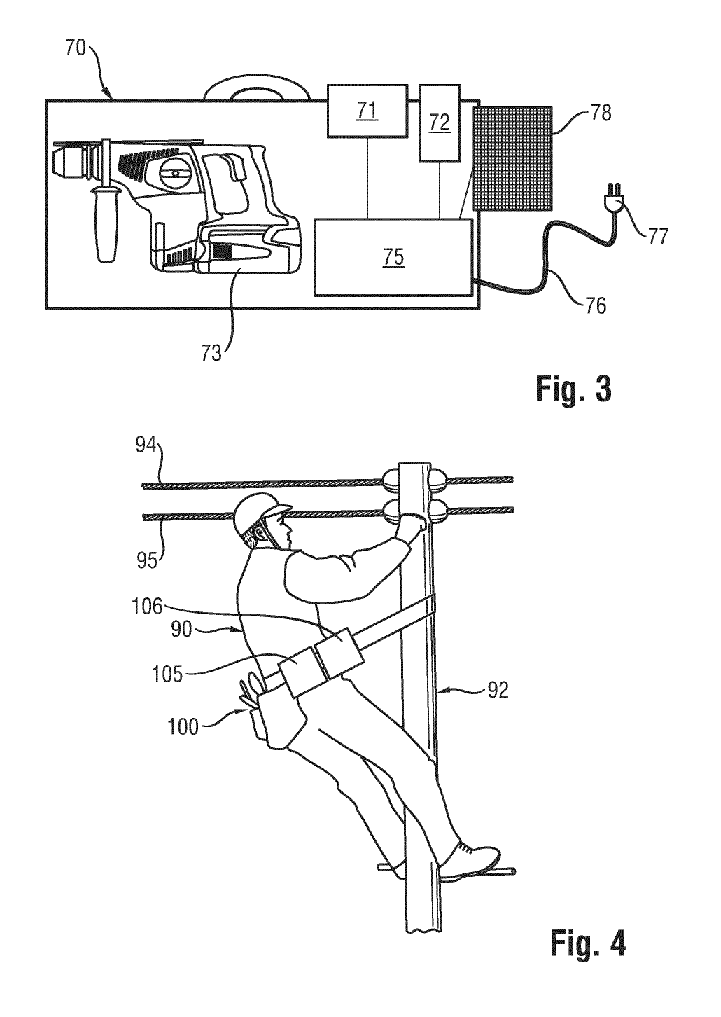

FIG. 3, a tool box, into which a mobile charging device, as is shown, for example, in FIGS. 1 and 2, is integrated; and

FIG. 4, a workman with a belt on which a mobile charging device and a battery are attached, during work on a pole.

### EMBODIMENT EXAMPLES

FIG. 1 shows a charging system 1 with a mobile charging device 5 in a greatly simplified manner. FIG. 2 shows a similar mobile charging device 45 as in FIG. 1, also in a greatly simplified manner. The mobile charging device 5, 45 can be connected via a mains cable 6, 46 and a mains plug 7, 47 to an electrical power supply network.

An energy storage device 10, 50, in which electrical energy can be stored, is located in a housing 8, 48 of the mobile charging device 5, 45, in accordance with an essential aspect of the invention. The electrical energy is delivered, for example, from the electrical power supply network if the mobile charging device 5, 45 is connected to the electrical power network via the mains cable 6, 46 and the mains plug 7, 47.

A converter 12, 52 is placed between the mains cable 6, 46 and the energy storage device 10, 50. The converter 12, 52 is used to convert electrical energy removed from the electrical power network. The converted electrical energy is then stored in the energy storage device 10, 50 and can be released as a function of the need.

The mobile charging device 5 shown in FIG. 1 comprises a control 15 with a control device and a data storage unit. The mobile charging device 5 comprises, moreover, an interface 20, which is also designated as a multifunction interface. Both data and electrical energy can be transferred wireless or contactless via the interface 20.

The charging system 1 shown in FIG. 1 comprises, moreover, mobile, electrically operable tool devices 25, 26, and 28, which are equipped with a removable battery. The tool devices 25, 26, and 28 comprise, moreover, an interface 31, 32 that makes possible a wireless or contactless energy transfer and a wireless or contactless data transfer. The interfaces 31, 32 are therefore also designated as multifunction interfaces.

The dotted arrows in FIG. 1 allude to the fact that the batteries of the tool devices 25, 26, and 28 can be charged contactless via the mobile charging device 5. For the charging of the batteries, the mobile charging device 5 can be connected to the electrical power supply network via the mains cable 6. In accordance with an essential aspect of the invention, the charging of the batteries of the tool devices 25, 26, and 28, however, can also take place via the energy storage device 10 integrated into the mobile charging device 5, without the mobile charging device 5 being thereby connected to the electrical power supply network.

The mobile charging device 45 shown in FIG. 2 comprises a charging regulator 54, which is used to supply a battery 56 as necessary with electrical energy from the energy storage device 50, which is integrated into the mobile charging device 45. The battery 46 can be supplied, via an interface 60, with electrical energy from the energy storage device 50. The battery 56 is constructed relatively easily and can be charged within a charging time of less than three minutes from the energy storage device 50. The battery 56 is preferably constructed as a power battery with an energy content of more than 450 kJ.

A charging of the battery 56 via the electrical power supply network could cause disturbances in the electrical power supply network, because, for example, electrical fuses are overloaded. The energy storage device 50 in accordance with the invention makes it possible to also charge quickly with a high energy content without the appearance of disturbances in the power supply network.

An arrow 61 alludes to the fact that the converter 52 removes electrical energy from the electrical energy supply network connected via the mains cable 47 and, over an average time period of, for example, 5 to 180 minutes, charges the electrical energy device 50 in the mobile charging device 45. As soon as the energy supply device 50 is filled, the battery 56 can be charged. Arrows 62 and 63 indicate that the electrical energy from the energy storage device 50 is supplied to the battery 56 via the charging regulator 54 and the interface 60.

A double arrow 64 between the charging regulator 54 and the interface 60 indicates that the electrical energy from the energy storage device 50 is not released in an uncontrolled manner. A communication interface integrated into the interface 60 ensures that the electrical energy from the energy storage device 50 is transferred to the battery 56 only if the battery 56 is correctly placed or arranged on the mobile charging device 45. The interface 60 is thereby constructed in such a manner that during the energy transfer, currents of above 100 amperes can be transferred.

FIG. 3 shows a simplified diagram of a tool box 70 with a carrying handle. The tool box 70 contains two batteries 71, 72, with which a drilling machine 73, contained also in the tool box 70, can be operated. In accordance with an essential aspect of the invention, a mobile charging device 75 is incorporated into the tool box 70, as is shown, for example, in FIGS. 1 and 2. The mobile charging device 75 comprises an energy storage device 50, which can be charged from an external power supply network via a mains cable 76 and a mains plug 77.

If the tool box 70 or the energy storage device integrated into the mobile charging device 75 is connected to the electrical power supply via the mains cable 76, the batteries 71, 72 are charged from the electrical power supply network, just like in the case of traditional charging devices. The energy storage device integrated into the mobile charging device 75 makes it possible, moreover, to charge the batteries 71 independently of the electrical power supply network, that is, independently of the mains supply and as a function of need.

In accordance with another aspect of the invention, a photovoltaic panel 78 is placed on the tool box 70. Via the photovoltaic panel 78, it is possible to charge the energy storage device integrated into the mobile charging device 75 even if the tool box 70 or the mobile charging device 75 is not connected to the external power supply network. In this way, it is possible to work even longer with the drilling machine 73, independently of the mains supply.

The connection between the batteries 71, 72 and the mobile charging device 75 can take place via contacts on the outside or the inside of the tool box 70. The connection between the batteries 71, 72 and the mobile charging device 75 can, however, also take place wireless or contactless.

FIG. 4 shows a workman 90 on a pole 92, who is carrying out repairs on lines 94, 95. The workman 90 is carrying a belt 100 with tools. There is a mobile charging device 105 and a battery 106 for an electrically operable tool on the belt 100. The mobile charging device 105 is constructed, for example, like the mobile charging devices 5, 45 shown in FIGS. 1 and 2. The battery 106 can be charged via the mobile charging device 105, independently of the mains supply, during work or assembly.

1. A mobile charging device for at least one electrically operable tool device, which comprises a battery that can be charged by the mobile charging device, the mobile charging device comprising an energy storage device for the storage of electrical energy that can be used to charge the battery of the electrically operable tool device independently of a mains supply.

2. The mobile charging device according to claim 1, wherein the mobile charging device has an interface for energy transfer between the energy storage device and the battery of the electrically operable tool device.

3. The mobile charging device according to claim 2, wherein the interface for the energy transfer can transfer currents of more than 100 amperes.

4. The mobile charging device according to claim 2, wherein the interface for the energy transfer is correlated with a control interface.

5. The mobile charging device according to claim 1, wherein the mobile charging device has a mains connection for the charging of the energy storage device in the mobile charging device.

6. The mobile charging device according to claim 1, wherein the mobile charging device is integrated into a tool box, a backpack, or a belt.

7. The mobile charging device according to claim 1, wherein the mobile charging device has a photovoltaic panel, which is connected to the energy storage device in the mobile charging device for energy transfer.

8. The mobile charging device according to claim 1, wherein the mobile charging device has a converter, which is upstream from the energy storage device, and/or has a charging regulator, which is downstream from the energy storage device.

9. A charging system for at least two electrically operable tool devices, which comprise at least one battery that can be charged by a mobile charging device according to claim 1, wherein the batteries of the tool devices have interfaces for energy transfer between the energy storage device and the batteries and/or for energy transfer between the batteries of the electrically operable tool devices.

10. The charging system according to claim 9, wherein the mobile charging device and/or the batteries of the electrically operable tool devices have communication interfaces for data transfer between the energy storage device and the batteries, and/or for data transfer between the batteries of the electrically operable tool devices.

11. The charging system according to claim 9, wherein the batteries of the electrically operable tool devices have interfaces for the energy transfer between the batteries and the electrically operable tool devices.

12. The charging system according to claim 10, wherein the interfaces for the energy transfer and the communication sites for the transfer are combined in a multifunction interface.

13. The charging system according to claim 9, wherein the batteries of the electrically operable tool devices are smaller or lighter than traditional batteries of electrically operable tool devices.

14. The charging system according to claim 9, wherein the electrically operable tool devices comprise hand tool devices.

15. A method for the operation of a charging system according to claim 9, the method comprising:
transferring energy between the energy storage device and the batteries; and/or
transferring energy between the batteries of the electrically operable tool devices.

16. The mobile charging device of claim 2, wherein the interface provides for contactless and/or wireless energy transfer between the energy storage device and the battery of the electrically operable tool device.

17. The mobile charging device according to claim 3, wherein the interface for the energy transfer is correlated with a control interface.

18. The mobile charging device according to claim 2, wherein the mobile charging device has a mains connection for the charging of the energy storage device in the mobile charging device.

19. The charging system according to claim 9, wherein the batteries of the tool devices have interfaces for the contactless and/or wireless energy transfer between the energy storage device and the batteries and/or for the contactless and/or wireless energy transfer between the batteries of the electrically operable tool devices.

20. The mobile charging device according to claim 2, wherein the mobile charging device has a photovoltaic panel, which is connected to the energy storage device in the mobile charging device for energy transfer.
